(19) United States
(12) Patent Application Publication
(10) Pub. No.: US 2026/0147194 A1
(43) Pub. Date: May 28, 2026

(54) LARGE-FIELD-OF-VIEW (FOV) PANORAMIC IMAGING SYSTEM BASED ON MULTIPLEXED REFLECTIVE SURFACE

(71) Applicant: ZHEJIANG UNIVERSITY, Hangzhou (CN)

(72) Inventors: Jian BAI, Hangzhou (CN); Fang KE, Hangzhou (CN); Shaohua GAO, Hangzhou (CN)

(73) Assignee: ZHEJIANG UNIVERSITY, Hangzhou (CN)

(21) Appl. No.: 19/114,427

(22) PCT Filed: Sep. 5, 2024
(86) PCT No.: PCT/CN2024/117027

§ 371 Date: Dec. 18, 2025

(30) Foreign Application Priority Data
Jul. 12, 2023 (CN) 202310851054.8

(51) Int. Cl. G02B 13/06; G02B 17/08

(52) U.S. Cl. CPC G02B 13/06; G02B 17/08

(57) ABSTRACT

This application provides a large-field-of-view (FoV) panoramic imaging system based on a multiplexed reflective surface, including a panoramic annular head unit (PAHU), a rear relay lens group, and an image sensor that are collinear, where a rear reflective surface (A3) of a second lens (PAL2) in the PAHU can be configured to reflect light from a glass side and light from an air side at the same time to respectively form a front FoV channel and a rear FoV channel; an object side of a first lens (RL1) in the rear relay lens group is provided with a central circular area (S1) and an outer annular area (S2); and the central circular area (S1) and the outer annular area (S2) are two even aspheric surfaces with different surface parameters, and are respectively configured to deflect light from the front FoV channel and the light from the rear FoV channel, such that the large-FoV panoramic imaging system can realize an imaging FoV range of (35°-120°)*360°.

The present application claims priority to the Chinese Patent Application No. 202310851054.8, filed with the China National Intellectual Property Administration (CNIPA) on Jul. 12, 2023, and entitled “LARGE-FIELD-OF-VIEW (FOV) PANORAMIC IMAGING SYSTEM BASED ON MULTIPLEXED REFLECTIVE SURFACE”, which is incorporated herein by reference in its entirety.

### TECHNICAL FIELD

The present disclosure relates to the technical field of panoramic optical imaging, and in particular to a large-field-of-view (FoV) panoramic imaging system based on a multiplexed reflective surface.

### BACKGROUND

The panoramic annular lens (PAL) system is used to image an object in the ultra-large-FoV range to the size-limited image sensor through refraction and reflection of the lenses at one time, thereby obtaining an ultra-large-FoV annular image. There is a circular blind area in the center of the image. The one-time imaging for the object in the ultra-large-FoV range to the image sensor is benefited from the organic combination of refraction surfaces and reflective surfaces in the head unit. However, as the imaging FoV range is expanded, the system is designed more difficultly. Meanwhile, the expansion of the imaging FoV range may also increase the size and weight of the system. This is adverse to miniaturization and lightweight of the system.

### SUMMARY

An objective of the present disclosure is to provide a large-FoV panoramic imaging system based on a multiplexed reflective surface. Based on the multiplexed reflective surface, the present disclosure realizes dual-channel imaging on the light path, shares the imaging FoV range on the light path of the conventional panoramic annular structure, and reduces the design difficulty of the large-FoV panoramic annular system, thereby further improving the imaging FoV.

To achieve the above-mentioned objective, an embodiment of the present disclosure provides a large-FoV panoramic imaging system based on a multiplexed reflective surface, including a panoramic annular head unit (PAHU) (10), a rear relay lens group (20), and an image sensor (30) that are collinear, where the PAHU (10) includes a first lens (PAL1) and a second lens (PAL2) arranged sequentially from an object side to an image side; the first lens (PAL1) is a meniscus lens with a positive power, and includes a front transmission surface (A1), a front reflective surface (A6), and a first transmission surface (A2); the second lens (PAL2) is a biconvex lens with a positive power, and includes a multiplexed reflective surface (A3) and a second transmission surface (A8); the rear relay lens group (20) includes at least two lenses arranged sequentially from the object side to the image side; the multiplexed reflective surface (A3) of the second lens (PAL2) can be configured to reflect light from a glass side and light from an air side at the same time to respectively form a front FOV channel (40) and a rear FoV channel (50); an object side of a first lens (RL1) in the rear relay lens group (20) is provided with a central circular area (S1) and an outer annular area (S2); the central circular area (S1) and the outer annular area (S2) are two even aspheres with different surface parameters, and are respectively configured to deflect light from the front FoV channel (40) and light from the rear FoV channel (50); and the large-FoV panoramic imaging system can realize an imaging FoV range of (35°-120°)*360°.

According to the specific embodiment of the present disclosure, the present disclosure has the following technical effects: The multiplexed reflective surface (A3) of the second lens (PAL2) in the PAHU (10) can be configured to reflect the light from the glass side and the light from the air side at the same time to respectively form the front FOV channel (40) and the rear FoV channel (50). The central circular area (S1) and the outer annular area (S2) at the object side of the first lens (RL1) are respectively configured to deflect the light from the front FOV channel (40) and the light from the rear FoV channel (50). Aberration correction is performed in the rear relay lens group (20). Images are formed on an image plane. The present disclosure shares the imaging FoV range on the light path of the conventional panoramic annular structure, reduces the design difficulty of the PAHU, and can make the large-FoV panoramic imaging system realize the imaging FoV range of (35°-120°)*360°.

### BRIEF DESCRIPTION OF THE DRAWINGS

To describe the technical solutions in the embodiments of present disclosure or in the prior art more clearly, the following briefly describes the accompanying drawings required for the embodiments. Apparently, the accompanying drawings in the following description show merely some embodiments of present disclosure, and a person of ordinary skill in the art may still derive other accompanying drawings from these accompanying drawings without creative efforts.

FIG. 1 is an optical structural view of a large-FoV panoramic imaging system according to an embodiment of the present disclosure;

FIG. 2 illustrates an annotation of each surface along a light path according to an embodiment of the present disclosure;

FIG. 3 is a partially enlarged view of a lens RL1 according to an embodiment of the present disclosure;

FIG. 4 is a partially enlarged view of a second lens PAL2 according to an embodiment of the present disclosure;

FIG. 5 illustrates an image of an image sensor according to an embodiment of the present disclosure;

FIG. 6 illustrates a modulation transfer function (MTF) curve of a front FoV channel under 486-656 nm according to an embodiment of the present disclosure;

FIG. 7 illustrates an MTF curve of a rear FoV channel under 486-656 nm according to an embodiment of the present disclosure;

FIG. 8 illustrates a standard spot diagram of a front FoV channel under 486-656 nm according to an embodiment of the present disclosure;

FIG. 9 illustrates a standard spot diagram of a rear FoV channel under 486-656 nm according to an embodiment of the present disclosure;

FIG. 10 illustrates a distortion curve of a front FoV channel under 486-656 nm according to an embodiment of the present disclosure;

FIG. 11 illustrates a distortion curve of a rear FoV channel under 486-656 nm according to an embodiment of the present disclosure;

FIG. 12 illustrates an optical path difference (OPD) map of a front FOV channel under 486-656 nm according to an embodiment of the present disclosure;

FIG. 13 illustrates an OPD map of a rear FoV channel under 486-656 nm according to an embodiment of the present disclosure;

FIG. 14 illustrates a chromatic difference of magnification of a front FoV channel under 486-656 nm according to an embodiment of the present disclosure;

FIG. 15 illustrates a chromatic difference of magnification of a rear FoV channel under 486-656 nm according to an embodiment of the present disclosure;

FIG. 16 illustrates a relative illumination (RI) curve of a front FoV channel under 486-656 nm according to an embodiment of the present disclosure; and

FIG. 17 illustrates an RI curve of a rear FoV channel under 486-656 nm according to an embodiment of the present disclosure.

### DETAILED DESCRIPTION OF THE EMBODIMENTS

The technical solutions in the embodiments of present disclosure are clearly and completely described below with reference to the drawings in the embodiments of present disclosure. Apparently, the described embodiments are only some rather than all of the embodiments of present disclosure. All other embodiments obtained by a person of ordinary skill in the art based on the embodiments of the present disclosure without creative efforts shall fall within the protection scope of the present disclosure.

It is to be noted that for ease of description, the thickness, size and shape of the lens are exaggerated slightly in the drawings. Specifically, the spheric or aspheric shape in the drawings is shown exemplarily. That is, the spheric or aspheric shape is not limited to the spheric or aspheric shape in the drawings. The drawings are merely exemplary and are not made strictly in proportion.

It should be noted that embodiments in the present disclosure and features in the embodiments may be combined with one another without conflict. The features, principles and other aspects of the present disclosure are described below in detail with reference to the accompanying drawings and the embodiments.

The present disclosure is further described in detail below with reference to the accompanying drawings and specific embodiments. Embodiments cannot be described here one by one, but the embodiments of the present disclosure do not limit those described below.

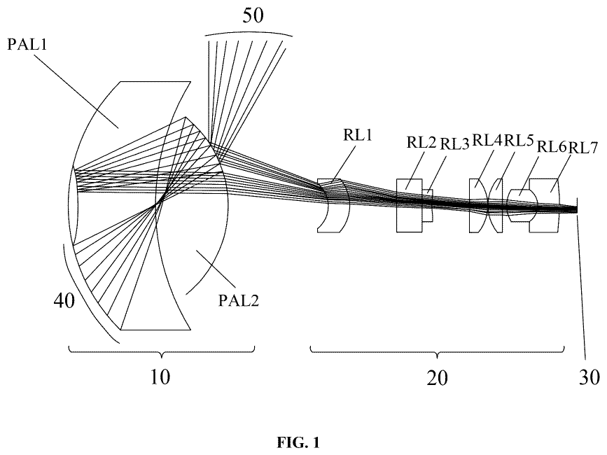

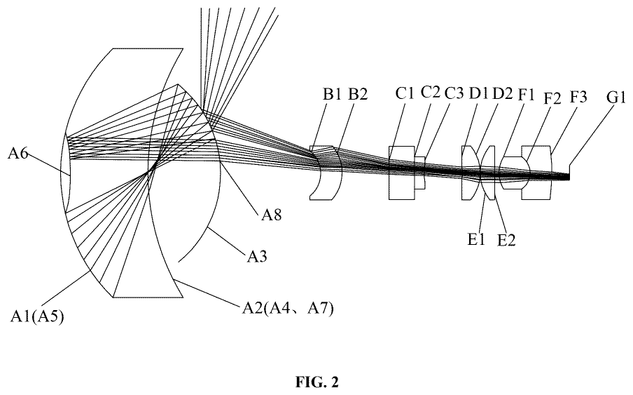

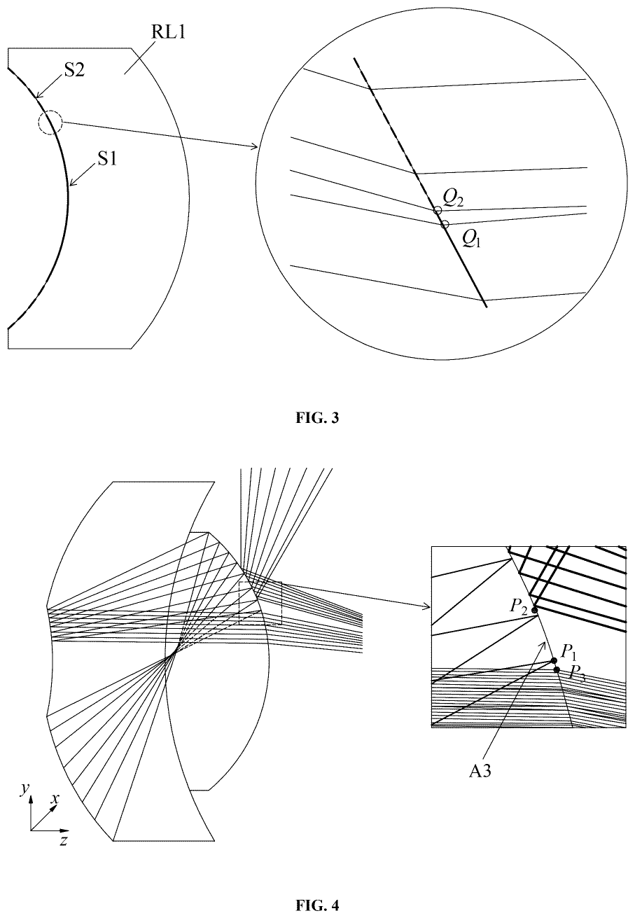

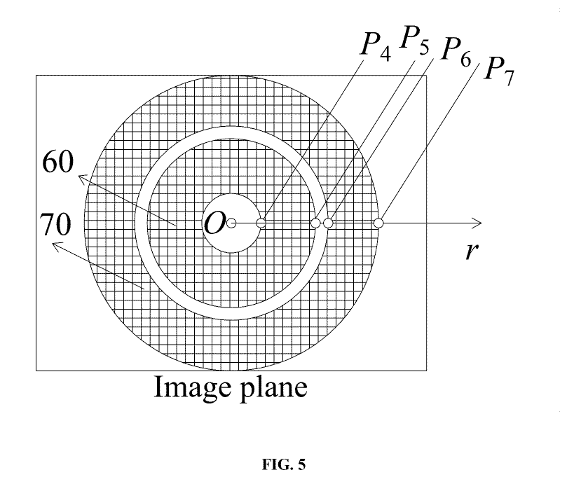

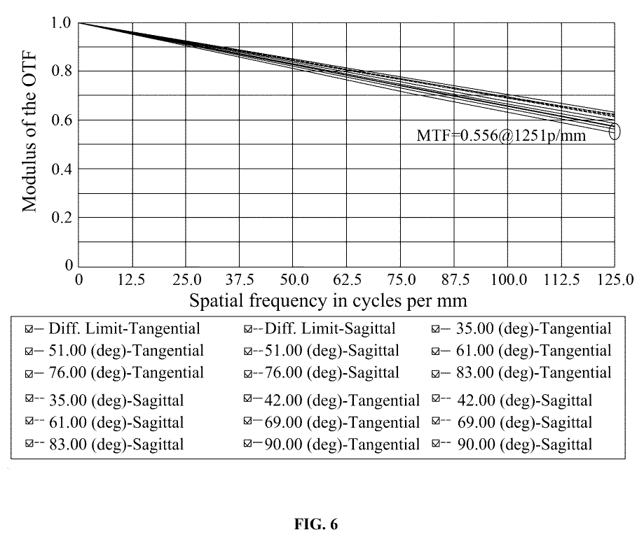

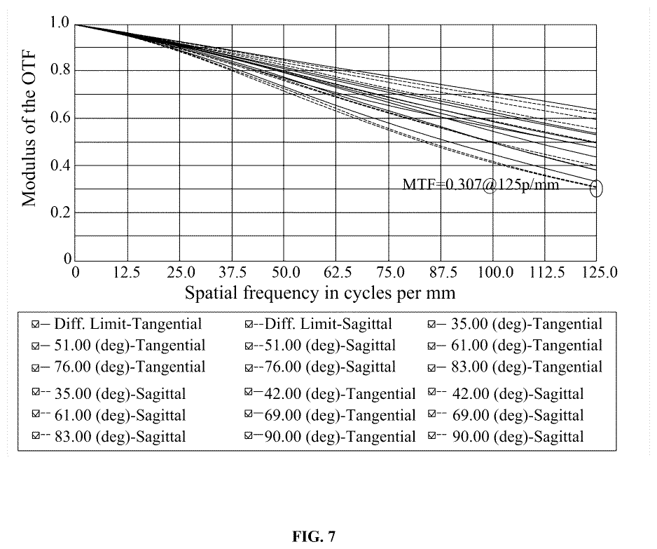

As shown in FIG. 1 and FIG. 2, an embodiment provides a large-FoV panoramic imaging system based on a multiplexed reflective surface, including a PAHU 10, a rear relay lens group 20, and an image sensor 30 that are collinear. The PAHU 10 includes a first lens PAL1 and a second lens PAL2 arranged sequentially from an object side to an image side. The first lens PAL1 is a meniscus lens with a positive power, and includes a front transmission surface A1, a front reflective surface A6, and a first transmission surface A2. The first lens PAL1 and the second lens PAL2 are cemented together, such that the second lens PAL2 is provided with the first transmission surface A2. The front reflective surface A6 is preferably located in a central area of the lens. An object-side curvature radius R_{A}_{₁} and an image-side curvature radius R_{A}_{₂} of the first lens PAL1 satisfy the following relationship:

$$0.7 < \frac{{R}_{{A}_{1}}}{{R}_{{A}_{2}}} < 0.75 .$$

The second lens PAL2 is the first lens PAL1 satisfy the following relationship: a biconvex lens with a positive power, and includes a multiplexed reflective surface A3 and a second transmission surface A8. An object-side curvature radius R_{A}_{₂} and an image-side curvature radius R_{A}_{₃} of the second lens PAL2 satisfy the following relationship:

$$2.13 < \frac{{R}_{{A}_{2}}}{{R}_{{A}_{3}}} < 2.18 .$$

The rear relay lens group 20 includes at least two lenses arranged sequentially from the object side to the image side. As shown in FIG. 1 and FIG. 2, the rear relay lens group includes seven lenses, including a first lens RL1, a second lens RL2, a third lens RL3, a fourth lens RL4, a fifth lens RL5, a sixth lens RL6, and a seventh lens RL7. The first lens RL1, the third lens RL3, the fourth lens RL4, the fifth lens RL5, and the seventh lens RL7 are meniscus lenses. The second lens RL2 is a biconcave lens. The sixth lens RL6 is a biconvex lens. The first lens RL1 is a single lens. A front surface (an object side) B1 of the first lens is a transmission surface, and is provided with a central circular area S1 and an outer annular area S2 having different surface parameters, namely two even aspheres. A rear surface B2 of the first lens is a transmission surface. The second lens RL2 and the third lens RL3 are cemented together, with a front surface C1 being a transmission surface, a rear surface C3 being a transmission surface, and a middle cemented surface C2 being a transmission surface. The fourth lens RL4 is a single lens, with a front surface D1 being a transmission surface, and a rear surface D2 being a transmission surface. The fifth lens RL5 is a single lens, with a front surface E1 being a transmission surface, and a rear surface E2 being a transmission surface. The sixth lens RL6 and the seventh lens RL7 are cemented together, with a front surface F1 being a transmission surface, a rear surface F3 being a transmission surface, and a middle cemented surface F2 being a transmission surface.

In the large-FoV panoramic imaging system provided by the embodiment, the multiplexed reflective surface A3 of the second lens PAL2 can be configured to reflect light from a glass side and light from an air side at the same time to respectively form a front FoV channel 40 and a rear FoV channel 50. Light in the two channels are respectively deflected by the central circular area S1 and the outer annular area S2 of the first lens RL1. After subjected to aberration correction of other lenses in the rear relay lens group 20, deflected light is received by the image sensor 30. Specifically, incident light from the front FoV channel 40 is refracted by the front transmission surface A1, reflected by the multiplexed reflective surface A3 to the front reflective surface A6, reflected by the front reflective surface A6 and then refracted by the second transmission surface A8 for outgoing. The outgoing light is converged to the image sensor 30 through the rear relay lens group 20. Incident light from the rear FoV channel 50 enters the rear relay lens group 20 after reflected by the multiplexed reflective surface A3, and converged to the image sensor 30 after subjected to aberration correction of the rear relay lens group 20. The photosensitive chip of the image sensor 30 may be Smartsens SC1330AT.

Specifically, the surface parameters of the central circular area S1 and the outer annular area S2 of the first lens RL1 in the rear relay lens group 20 are designed as follows:

In order to further control the aberration and improve the image quality, the object side of the first lens RL1 is divided into the central circular area S1 and the outer annular area S2. The two areas use different rotationally symmetric even aspheric coefficients, with corresponding surface parameters z(r) designed as follows:

$$z ( r ) = \{ \begin{matrix}\frac{{c}_{1} \cdot {r}^{2}}{1 + \sqrt{1 - ( 1 + {k}_{1} ) {c}_{1}^{2} \cdot {r}^{2}}} + {a}_{4} {r}^{4} + {a}_{6} {r}^{6} + … {a}_{16} {r}^{16} , 0 < r < {r}_{1} \\ \frac{{c}_{2} \cdot {r}^{2}}{1 + \sqrt{1 - ( 1 + {k}_{2} ) {c}_{2}^{2} \cdot {r}^{2}}} + {b}_{4} {r}^{4} + {b}_{6} {r}^{6} + … {b}_{16} {r}^{16} , {r}_{1} < r < {r}_{2} .\end{matrix}$$

In the foregoing equation, z is a sag of the surface, and represents a difference between a coordinate of any point on the surface and a coordinate of a vertex of the surface along an optical axis, r₁ is a radial coordinate at a boundary between an inner asphere and an outer asphere, r₂ is a maximum radial coordinate of the outer annular area S2, c₁ and c₂ are respectively a curvature of the inner asphere at a vertex and a curvature of the outer asphere at a vertex, k₁ and k₂ are respectively a conic constant of the inner asphere and a conic constant of the outer asphere, and aᵢ and bⱼ (i, j=4, 6, 8, . . . , 16) are respectively a high-order aspheric coefficient of the inner asphere, and a high-order aspheric coefficient of the outer asphere.

When r=r₁, a sag of the object side of the first lens RL1 changes abruptly, with a variation expressed as:

$$Δ z ( {r}_{1} ) = \{ \frac{{c}_{2} \cdot {r}_{1}^{2}}{1 + \sqrt{1 - ( 1 + {k}_{2} ) {c}_{2}^{2} \cdot {r}_{1}^{2}}} + {b}_{4} {r}_{1}^{4} + {b}_{6} {r}_{1}^{6} + … {b}_{16} {r}_{1}^{16} \} - \{ \frac{{c}_{2} \cdot {r}_{1}^{2}}{1 + \sqrt{1 - ( 1 + {k}_{1} ) {c}_{1}^{2} \cdot {r}_{1}^{2}}} + {a}_{4} {r}_{1}^{4} + {a}_{6} {r}_{1}^{6} + … {a}_{16} {r}_{1}^{16} \}$$

By dividing the object side of the first lens RL1 into inner and outer parts, a number of variables in the design is greatly increased, but additional constraints are also introduced. As shown in FIG. 3, the light from the front FoV channel 40 is refracted by the central circular area S1 of the first lens RL1 in the rear relay lens group 20, with a series of intersections with the central circular area S1. An intersection with a maximum radial coordinate is labeled as Q₁. The light from the rear FoV channel 50 is reflected by the outer annular area S2 of the first lens RL1, with a series of intersections with the outer annular area S2. An intersection with a minimum radial coordinate is labeled as Q₂. In order to constrain a falling position of the light, the radial coordinate r_{Q}_{₁} of the Q₁ and the radial coordinate r_{Q}_{₂} of the Q₂ satisfy: r_{Q}_{₁}<r_{Q}_{₂}.

Since the reflective surface of the PAHU is multiplexed to reflect the light, structural parameters of the PAHU affect images from the light of the two channels at the same time. Hence, the structural design of the PAHU is very important. As shown in FIG. 4, the light from the front FOV channel 40 is refracted by the front transmission surface A1 and the first transmission surface A2, reflected by the multiplexed reflective surface A3 and the front reflective surface A6, and transmitted by the second transmission surface A8, thereby entering the rear relay lens group 20. The light from the rear FOV channel 50 is reflected by the multiplexed reflective surface A3 to enter the rear relay lens group 20. The light from the front FoV channel 40 has a series of intersections with the multiplexed reflective surface A3. An intersection with a minimum radial coordinate is labeled as P₁. The light from the rear FoV channel 50 also has a series of intersections with the multiplexed reflective surface A3. An intersection with a minimum radial coordinate is labeled as P₂. The light from the front FoV channel 40 has a series of intersections with the second transmission surface A8 of the second lens PAL2. An intersection with a maximum radial coordinate is labeled as P₃. In order not to obstruct the light from the two channels, the radial coordinate r_{P}_{₁} of the P₁, the radial coordinate r_{P}_{₂} of the P₂, and the radial coordinate r_{P}_{₃} of the P₃ satisfy the following constraints: r_{P}_{₁}>r_{P}_{₃}; and r_{P}_{₂}>r_{P}_{₃}.

Besides the above constraints, the falling point of light on an image plane should also be controlled strictly. As shown in FIG. 5, the light from the front FOV channel 40 and the light from the rear FoV channel 50 respectively form an inner annular area and an outer annular area on the image plane of the image sensor 30, which are respectively a front FoV channel imaging area 60 and a rear FoV channel imaging area 70. With an intersection between the optical axis and the image plane as an origin O, a polar coordinate system is established. The light from the front FoV channel 40 at angles of 35° and 90° is respectively intersected with an r-axis on the image plane of the image sensor 30 at P₄ and P₅. The light from the rear FOV channel 50 at angles of 90° and 120° is respectively intersected with the r-axis on the image plane at P₇ and P₆. Since imaging performance of the two channels is not identical, and the annular image of the rear FoV channel 50 is inside-out, images of the two channels cannot be overlapped, namely there is a certain gap between the P₅ and the P₆, and a radial coordinate r_{P}_{₅} of the P₅ and a radial coordinate r_{P}_{₆} of the P₆ satisfy the following constraint: r_{P}_{₅}<r_{P}_{₆}.

In design optimization, in order to make Δz(r₁) approach zero, constraints r_{Q}_{₁}<r_{Q}_{₂}, r_{P}_{₁}>r_{P}_{₃}, r_{P}_{₂}>r_{P}_{₃}, and r_{P}_{₅}<r_{P}_{₆} are added to a merit function, to control radial positions of the light on critical surfaces, thereby ensuring that the light from the front FOV channel 40 and the light from the rear FOV channel 50 do not interfere with each other. With parameter optimization on z(r), the surface parameters of the central circular area (S1) and the outer annular area (S2) are determined.

In a specific experiment, aspheric parameters, except the k₁, a₄, a₆, k₂, b₄, b₆, b₈, and bio, are all zero in the design equation of the surface parameter z(r) of the rotationally symmetric even asphere, specifically as shown in Table 1:

TABLE 1

| Aspheric | | |
|---|---|---|
| parameter | S1 area | S2 area |
| k₁(k₂) | k₁ = 5.258107003384708E−001 | k₂ = −7.195690732566317E−001 |
| a₄(b₄) | a₄ = 2.774545056694520E−004 | b₄ = 1.961704273083075E−003 |
| a₆(b₆) | a₆ = 9.687370317277264E−006 | b₆ = −9.300383054343469E−005 |
| a₈(b₈) | a₈ = 0 | b₈ = 2.023606991205106E−006 |
| a₁₀(b₁₀) | a₁₀ = 0 | b₁₀ = −1.851929504818376E−008 |

In the embodiment, a total track length TTL_{head} of the PAHU 10 and a total track length TTL_{rear relay lens group} of the rear relay lens group 20 are further controlled to satisfy the following relationship:

$$0.65 < \frac{{TTL}_{PAHU}}{{TTL}_{rear relay lens group}} < 0.7 .$$

In response to a fixed total track length of the PAHU, limiting the total track length of the rear relay lens group effectively to compress the total track length of the whole optical system is beneficial to miniaturization, lightweight, low cost and portability of the panoramic annular optical system.

By reasonably providing the curvature radius of the first lens PAL1 and the curvature radius of the second lens PAL2, the front FoV channel 40 has an imaging FOV range of (35°-90°)*360°, and the rear FoV channel 50 has an imaging FoV range of (90°-120°)*360°. The two channels are combined together, such that the panoramic imaging system can realize the imaging FoV range of (35°-120°)*360°, has a resolution of 1.2-million pixels to visible light, and has advantages of the stable image, large imaging range, and good image quality.

An example of the designed large-FoV panoramic imaging system is further provided in the embodiment. There are the following specific parameters, including a center thickness, a refractive index, an Abbe number, an effective semi-diameter, a curvature radius, a conic constant, and a high-order even aspheric coefficient, as shown in Table 2 and Table 3.

TABLE 2

| Surface | Center | Refractive | Abbe | Effective |
|---|---|---|---|---|
| number | thickness | index | number | semi-diameter |
| A1 | 23.00 | 1.60-1.64 | 55-59 | 32-34 |
| A2 | 18.68 | 1.56-1.60 | 56-60 | 32-34 |
| A3 | −18.68 | MIRROR | 0 | 23-25 |
| A4 | −23.00 | 1.60-1.64 | 55-59 | 32-34 |
| A5 | 2.26 | 1.60-1.64 | 55-59 | 9-11 |
| A6 | 20.74 | MIRROR | 0 | 10-12 |
| A7 | 18.68 | 1.56-1.60 | 56-60 | 9-11 |
| A8 | 26.32 | | | 8-10 |
| B1-S1 | 5.6046 | 1.60-1.65 | 63-67 | 3-5 |
| B1-S2 | 5.6046 | 1.60-1.65 | 63-67 | 4-6 |
| B2 | 12.3775 | | | 4-6 |
| C1 | 6.5157 | 1.56-1.60 | 70-74 | 3-5 |
| C2 | 2.6466 | 1.81-1.85 | 22-26 | 2-4 |
| C3 | 10.0050 | | | 2-4 |
| D1 | 4.7580 | 1.56-1.60 | 70-74 | 1-3 |
| D2 | 0.0740 | | | 1-3 |
| E1 | 3.5990 | 1.56-1.60 | 43-47 | 2-4 |
| E2 | 1.2329 | | | 1-3 |
| F1 | 8.0825 | 1.56-1.60 | 70-74 | 2-4 |
| F2 | 5.7048 | 1.81-1.85 | 22-26 | 1-3 |
| F3 | 4.6818 | | | 1-3 |
| G1 | — | | | 1-2 |

TABLE 3

| Surface | Radius of | Conic | High-order even |
|---|---|---|---|
| number | Curvature | constant | aspheric coefficient |
| A1 | 46-48 | 0 | 0 |
| A2 | 64-66 | 0 | 0 |
| A3 | −31-−29 | 0 | 0 |
| A4 | 64-66 | 0 | 0 |
| A5 | 46-48 | 0 | 0 |
| A6 | −56-−54 | 12-14 | 0 |
| A7 | 64-66 | 0 | 0 |
| A8 | −31-−29 | 0 | 0 |
| B1-S1 | −8-−6 | k₁ = 0.526 | a₄ = 2.77 × 10⁻⁴ |
| | | | a₆ = 9.69 × 10⁻⁶ |
| B1-S2 | −7-−5 | k₂ = −0.720 | b₄ = 1.96 × 10⁻³ |
| | | | b₆ = −9.30 × 10⁻⁵ |
| | | | b₈ = 2.02 × 10⁻⁶ |
| | | | b₁₀ = −1.85 × 10⁻⁸ |
| B2 | −12-−10 | 0-1 | 0 |
| C1 | −184-−182 | 0 | 0 |
| C2 | 1293-1295 | 0 | 0 |
| C3 | 26-28 | 0 | 0 |
| D1 | −8-−6 | 0 | 0 |
| D2 | −11-−9 | 0 | 0 |
| E1 | 11-13 | 0 | 0 |
| E2 | 149-151 | 0 | 0 |
| F1 | 8-10 | 0 | 0 |
| F2 | −6-−4 | 0 | 0 |
| F3 | −37-−35 | −101-−99 | 0 |
| G1 | Infinity | 0 | 0 |

A1 and A5 are the same surface, and A2, A4, and A7 are the same surface. However, the thicknesses are different, because the thickness term in optical design software refers to a specified thickness from the surface to the next surface. Due to two reflections of the light path, the light passes through the surface A1 twice. Whenever the light passes through the surface, the next surface to which the light reaches may be different, thus causing the different thicknesses of the same surface. For example, since the light will reach the surface A3, the surface A2 has a positive thickness. The surface A4 has a negative thickness, because the light will get back to the surface A5.

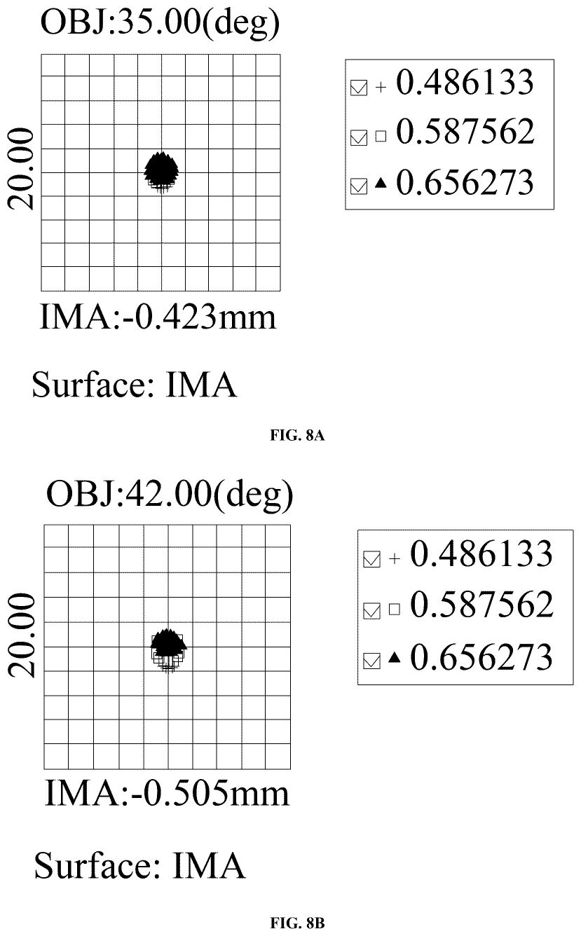

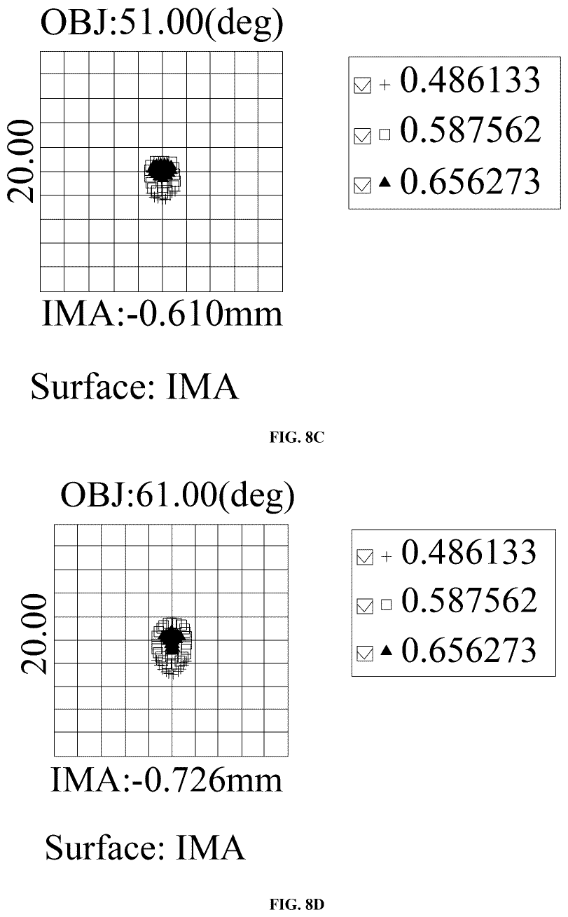

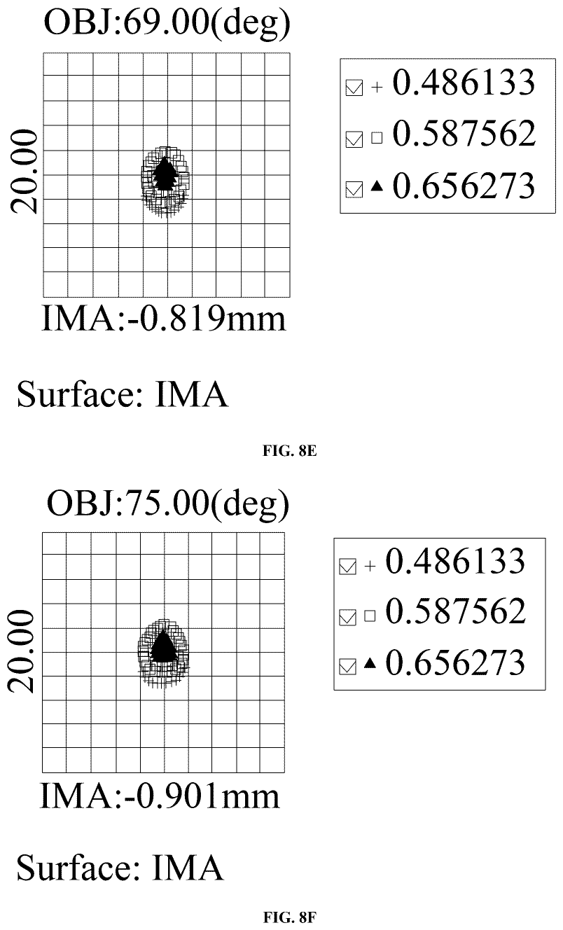

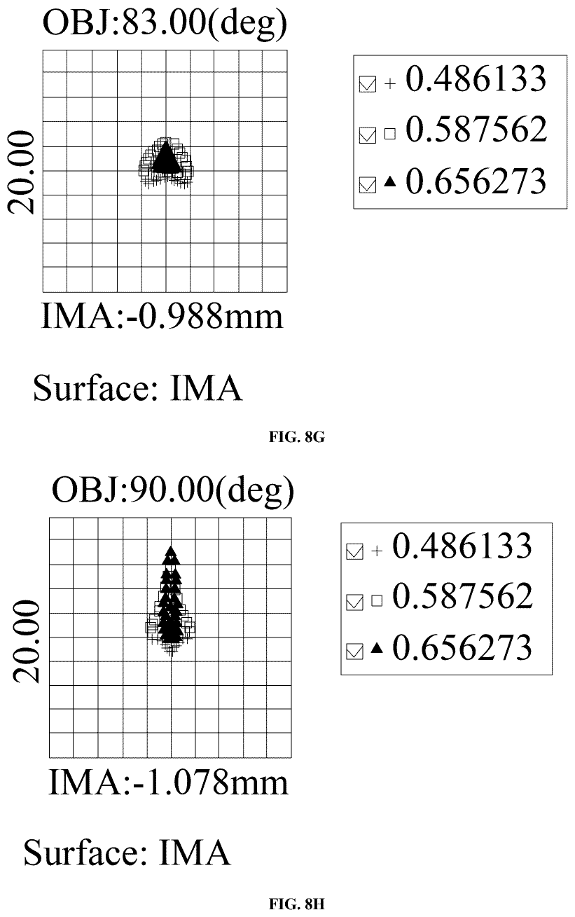

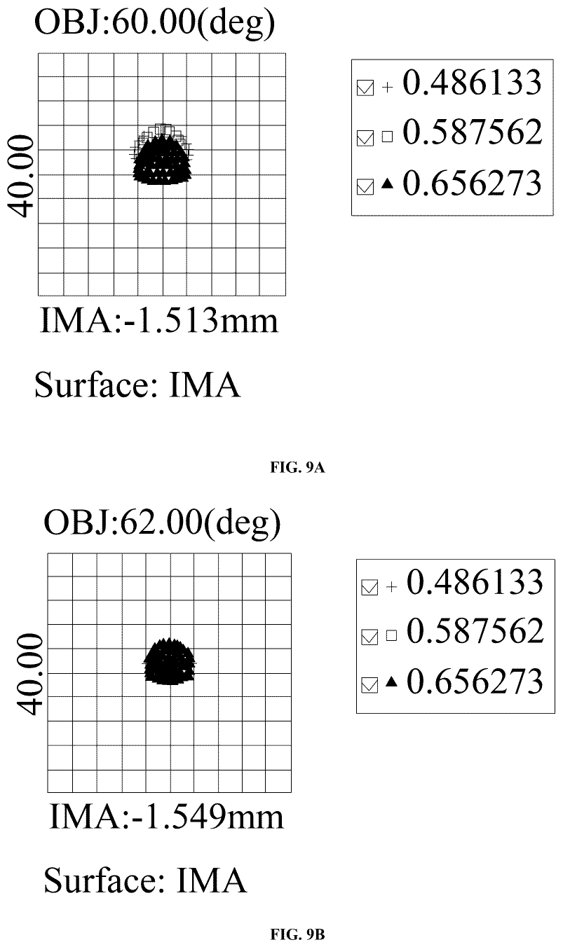

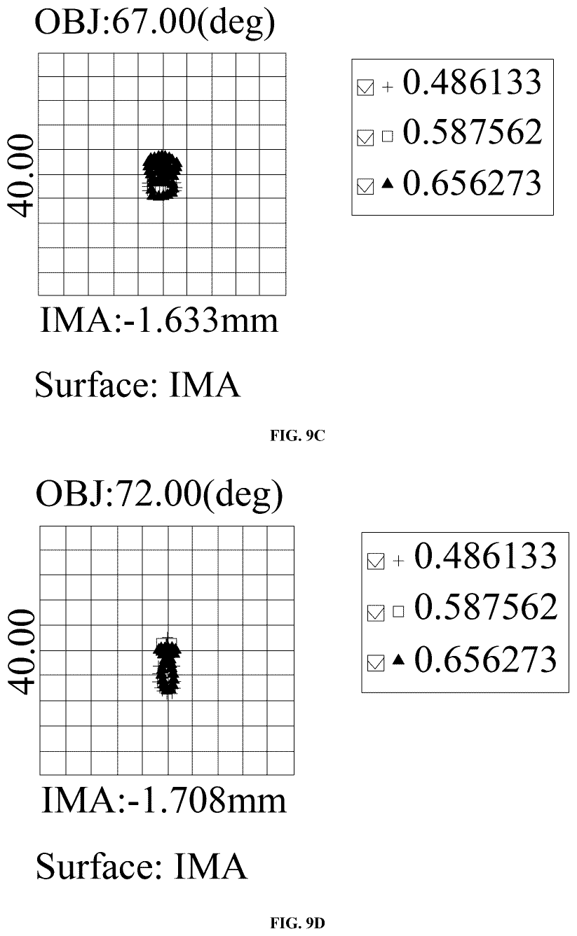

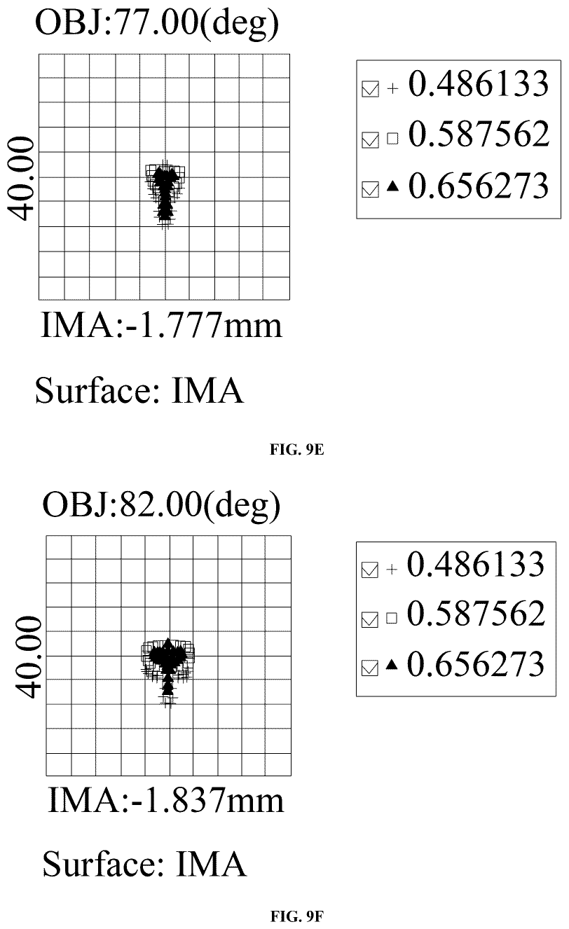

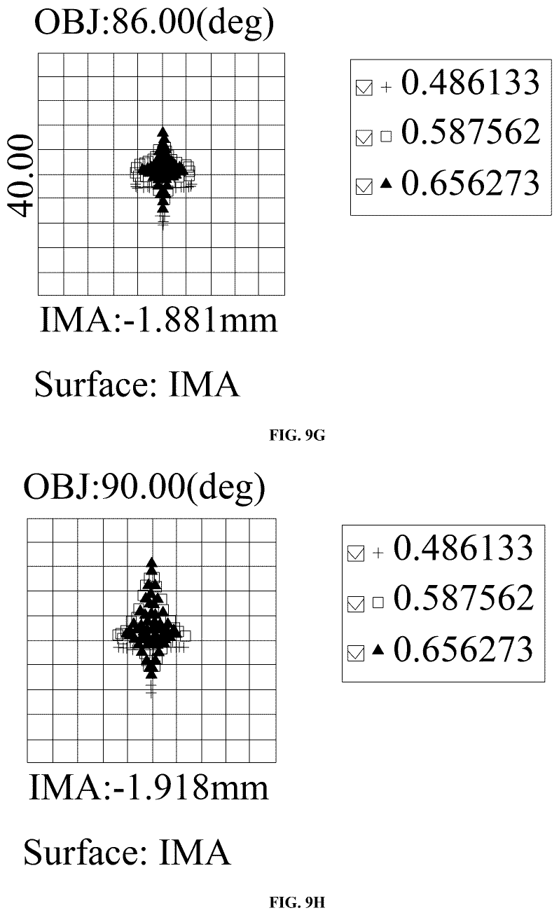

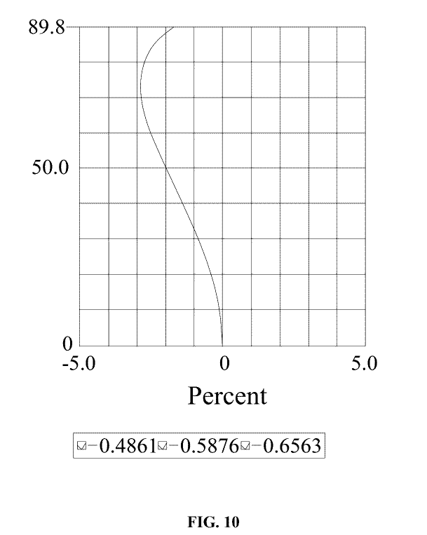

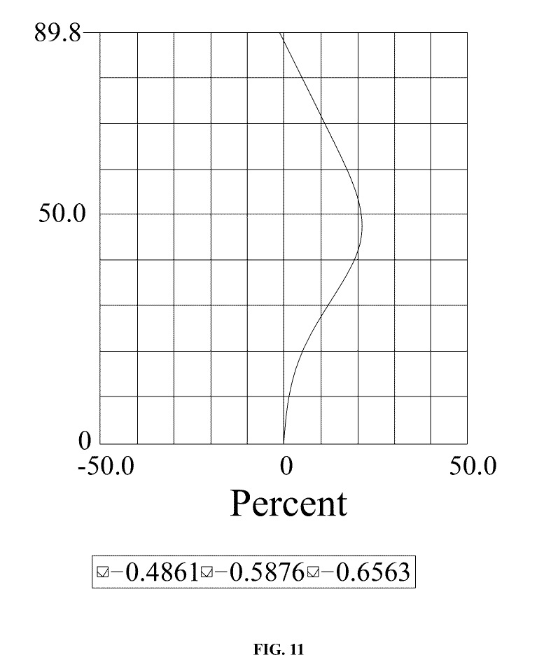

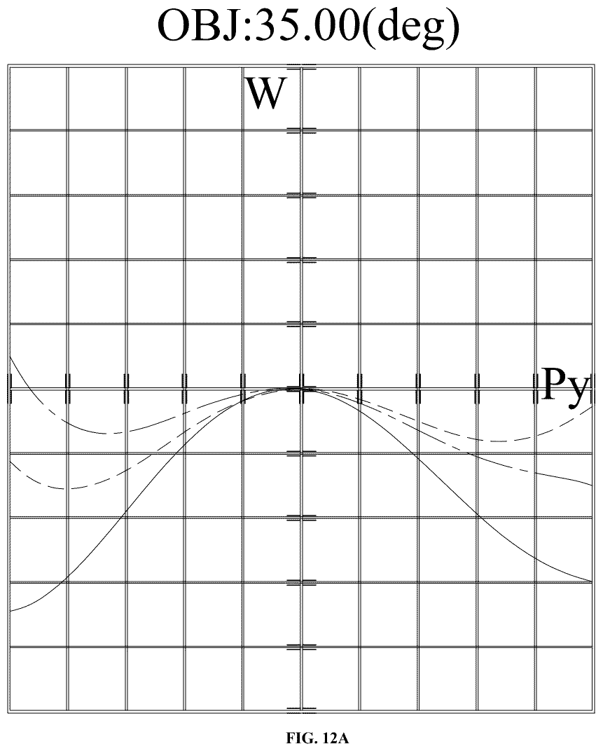

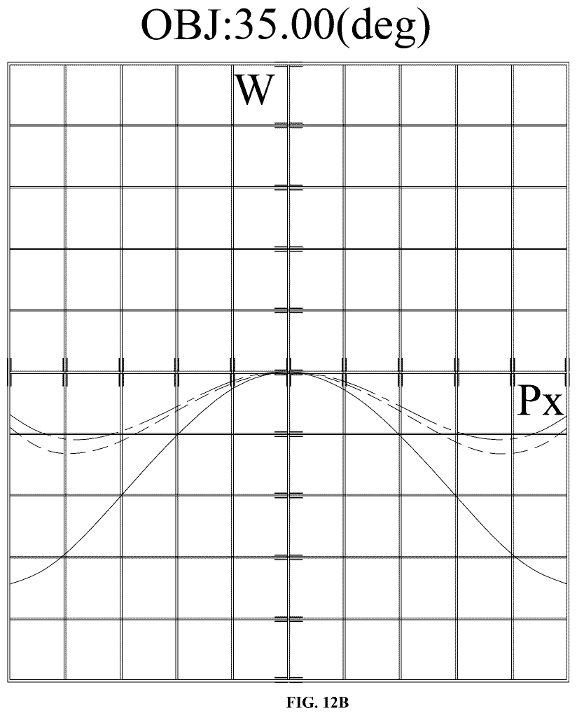

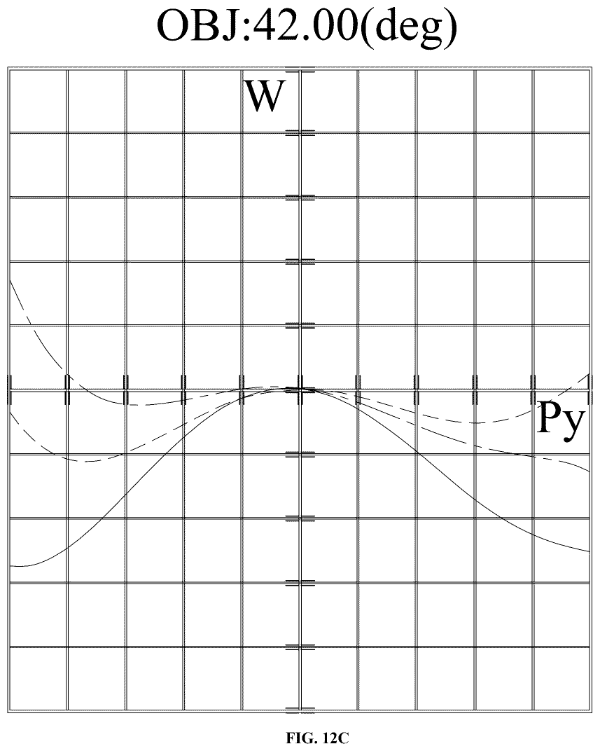

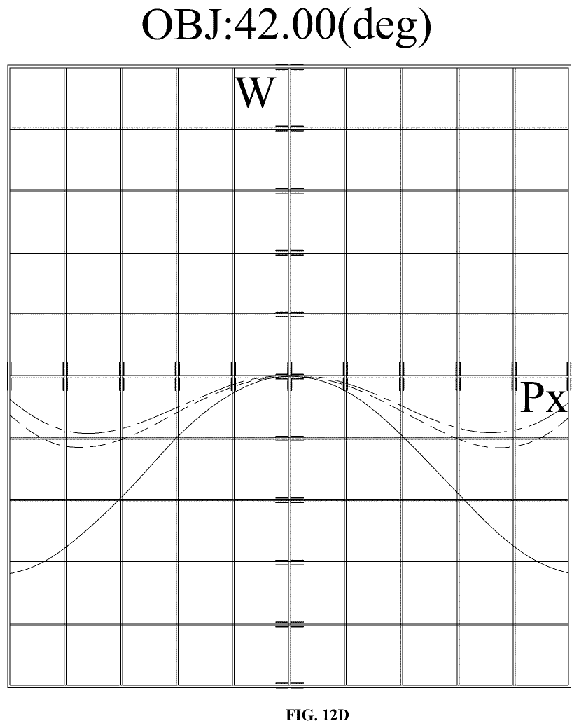

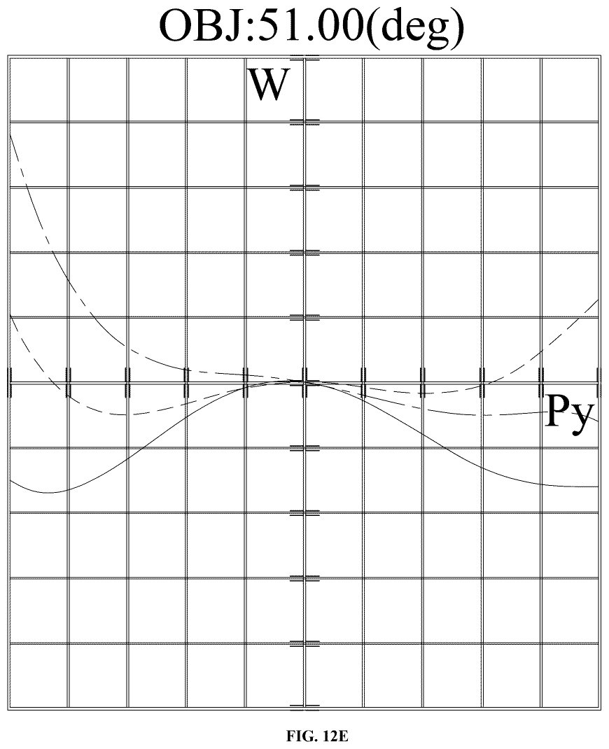

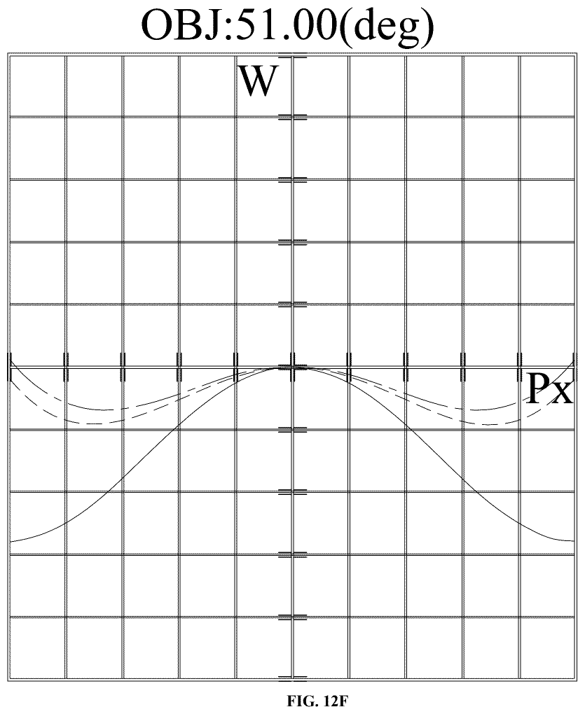

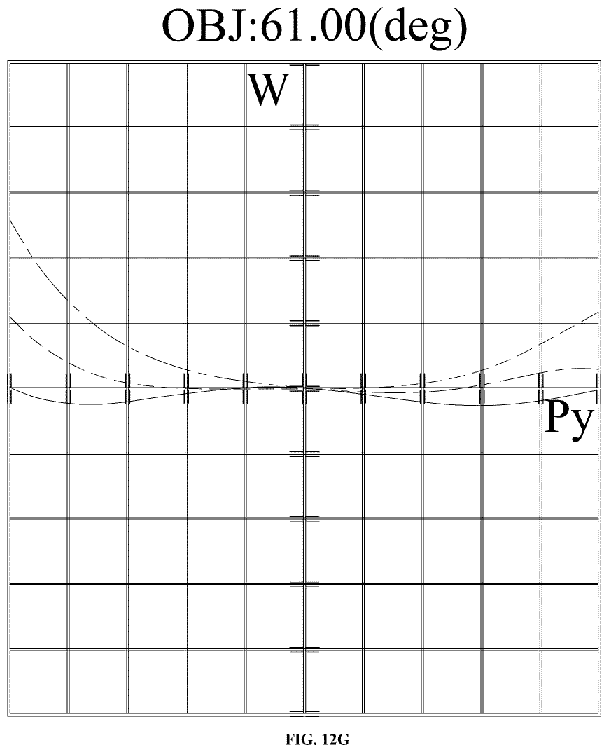

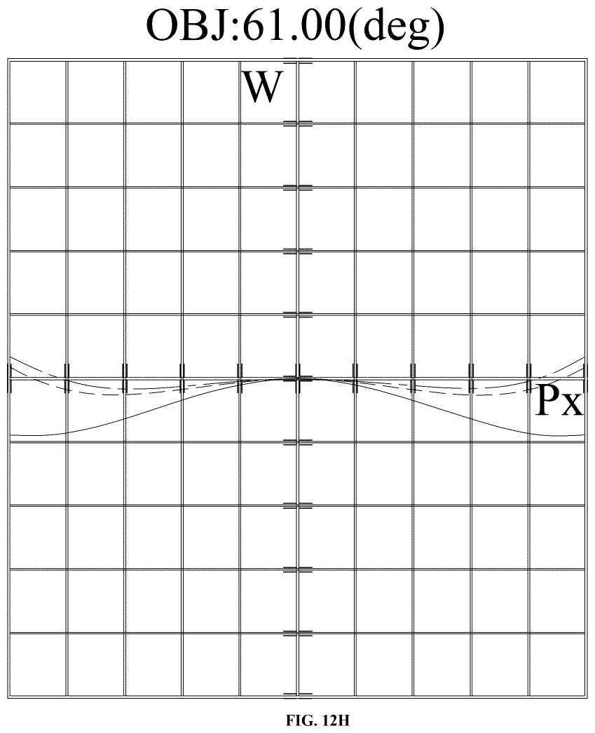

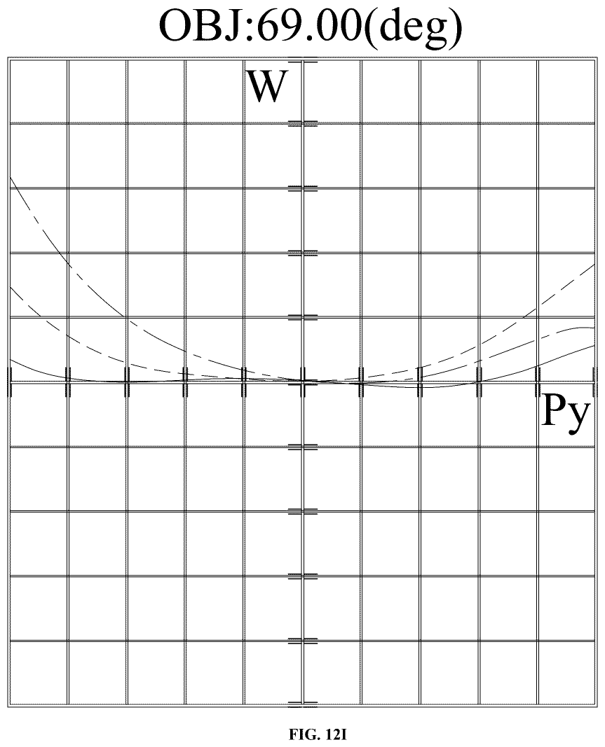

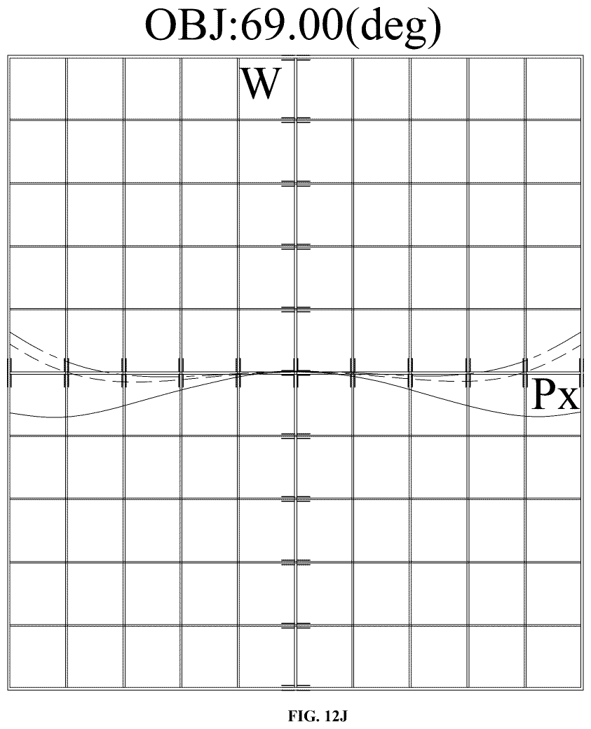

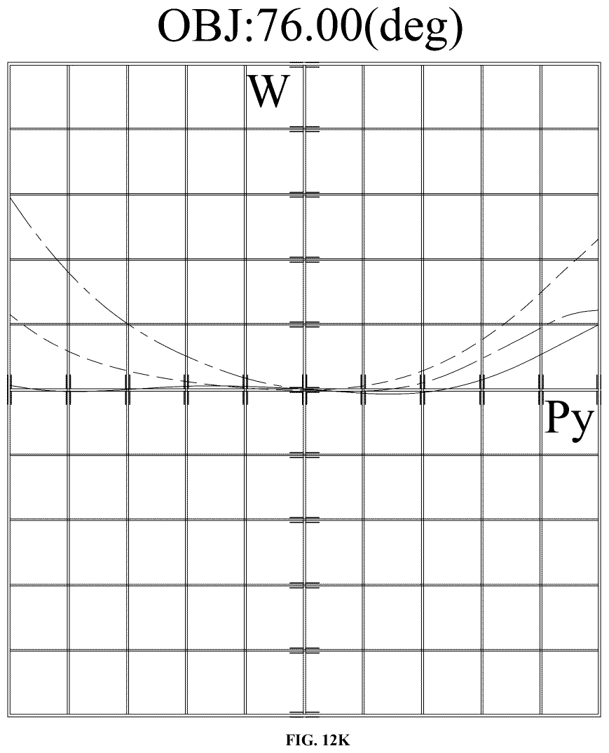

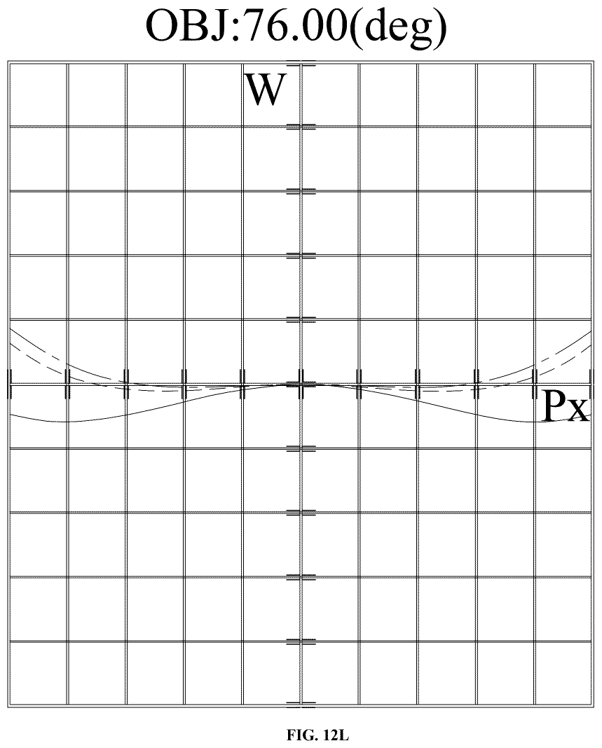

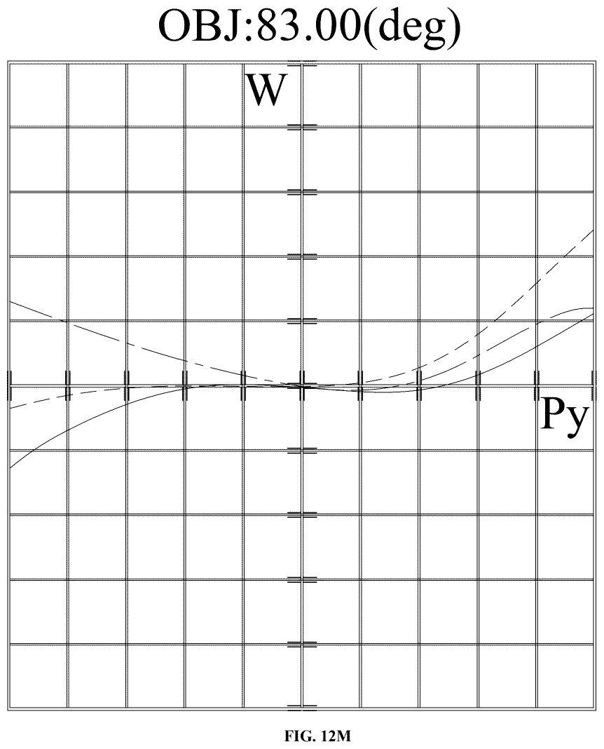

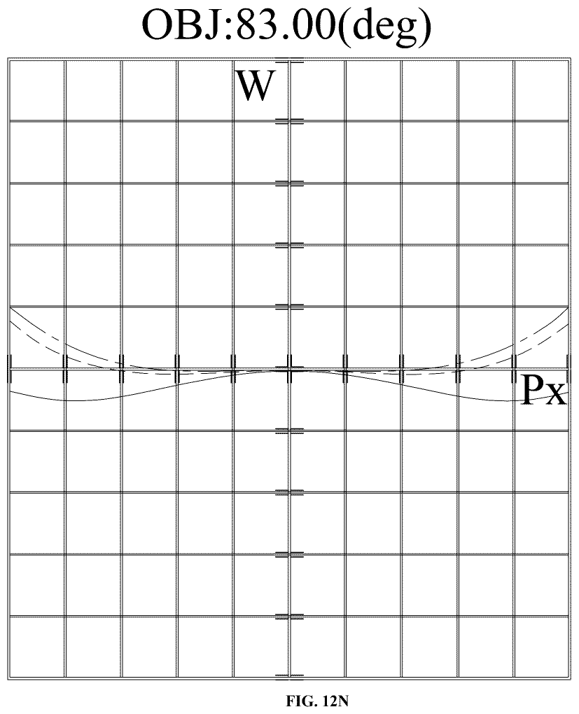

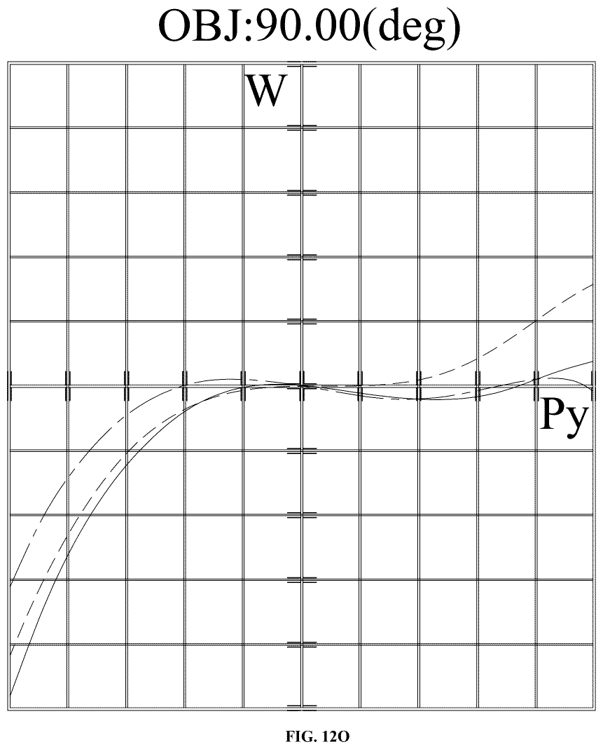

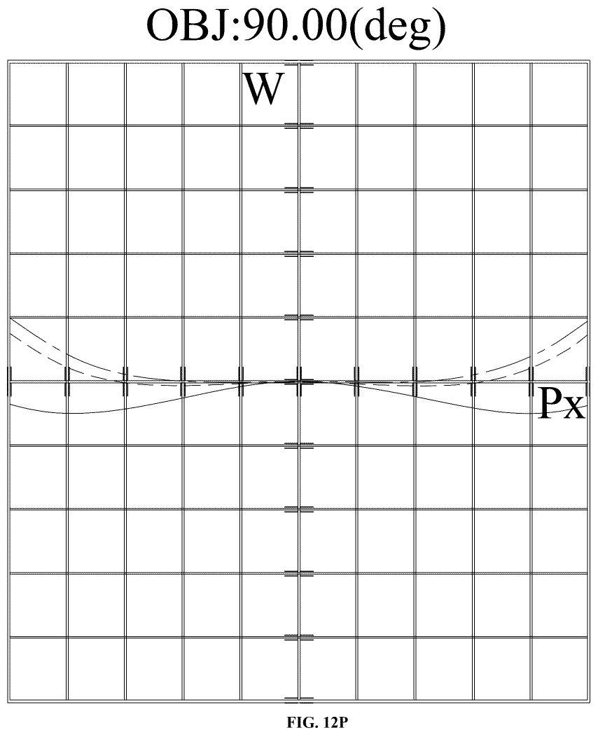

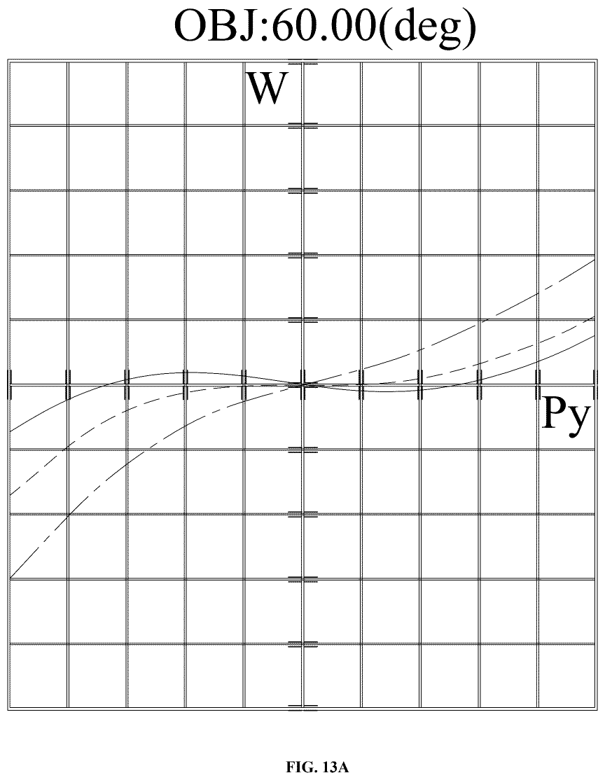

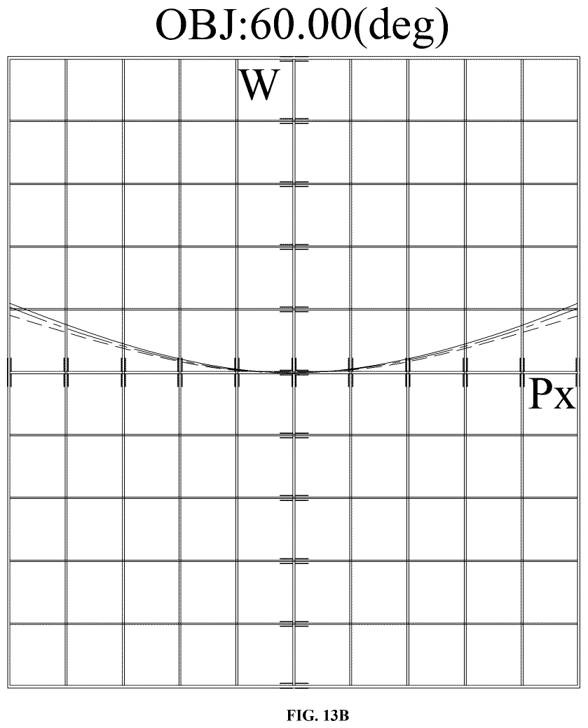

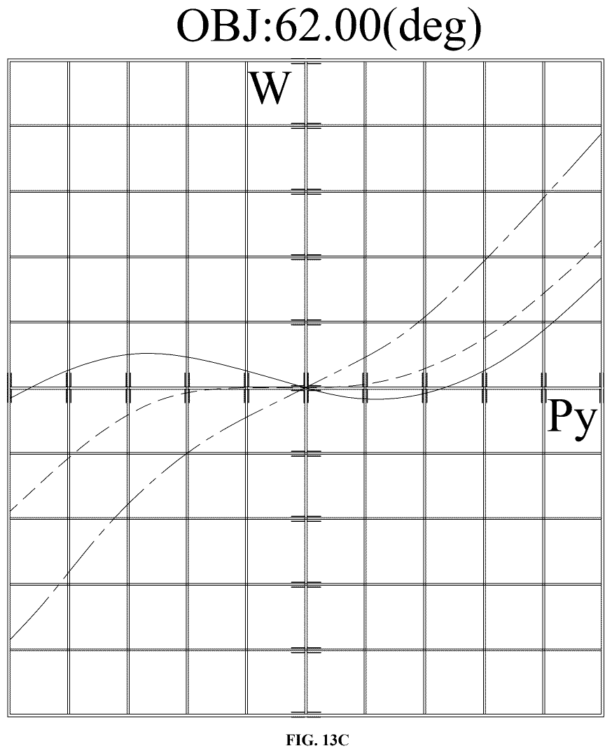

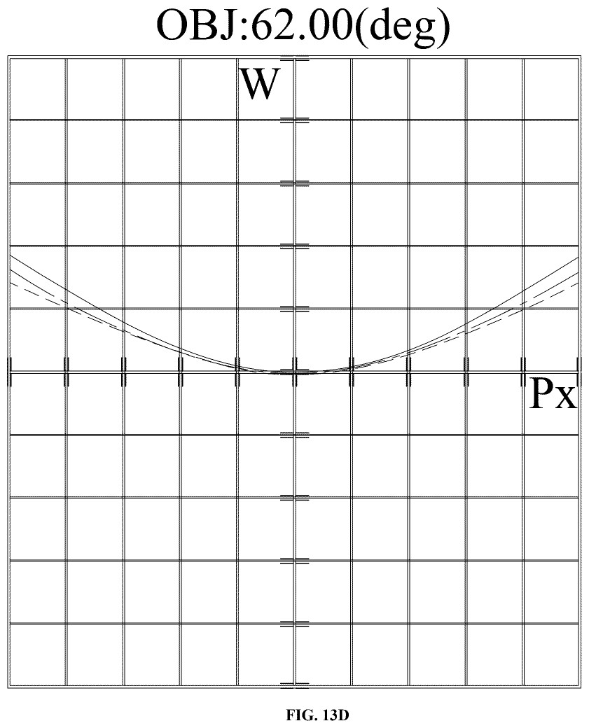

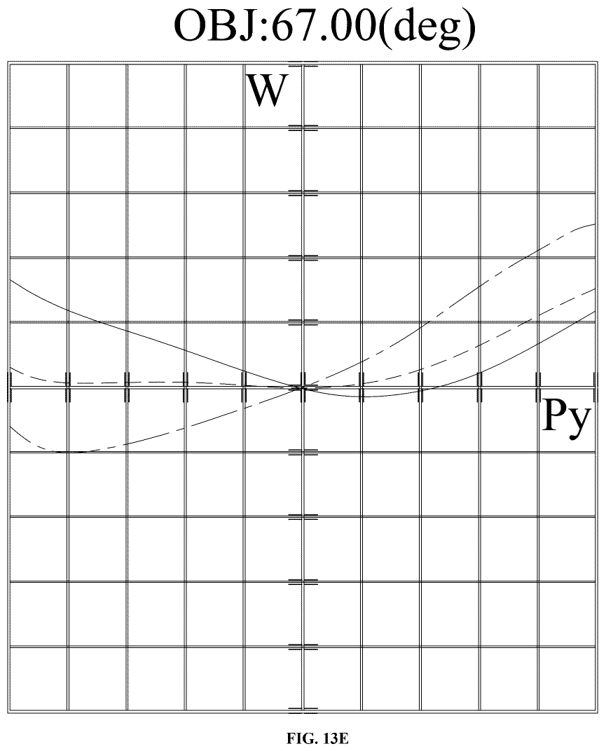

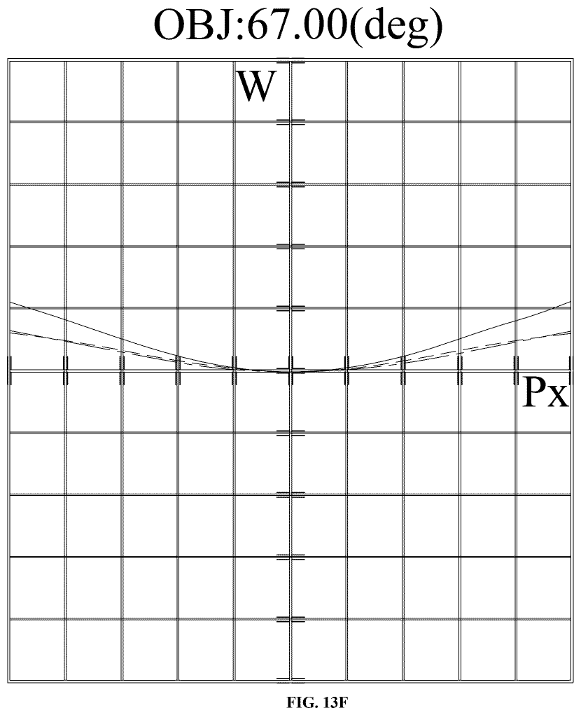

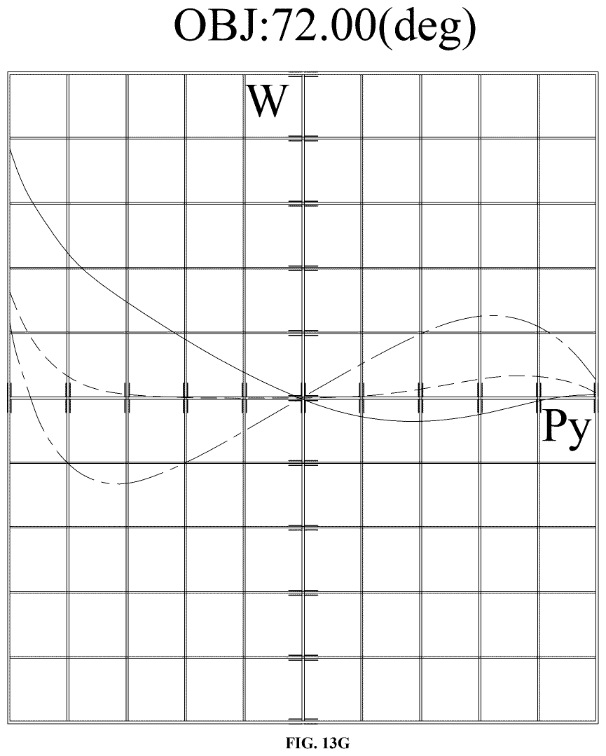

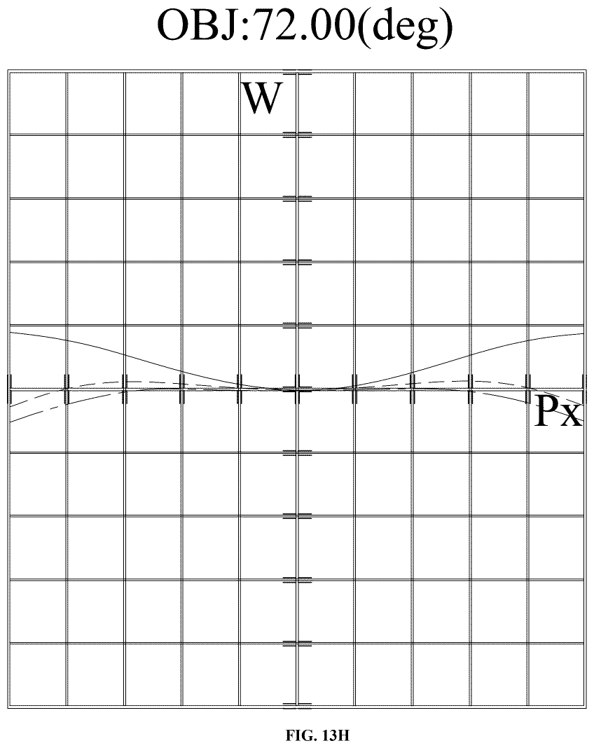

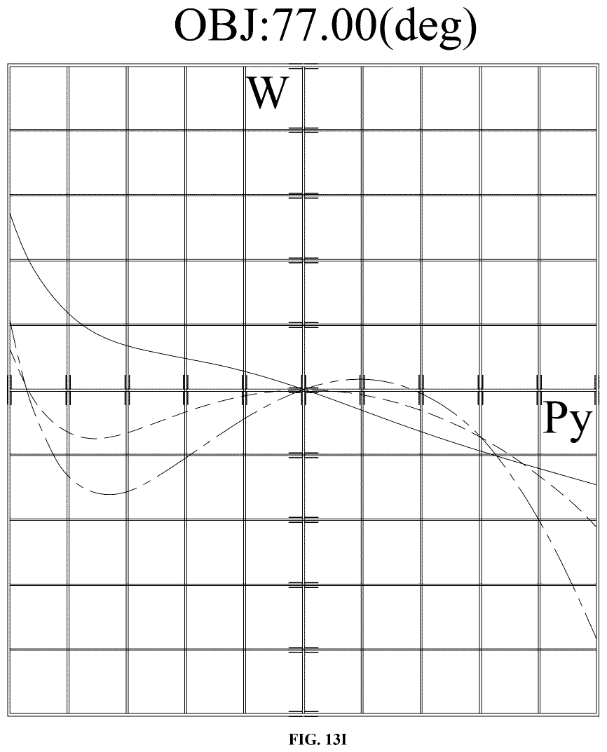

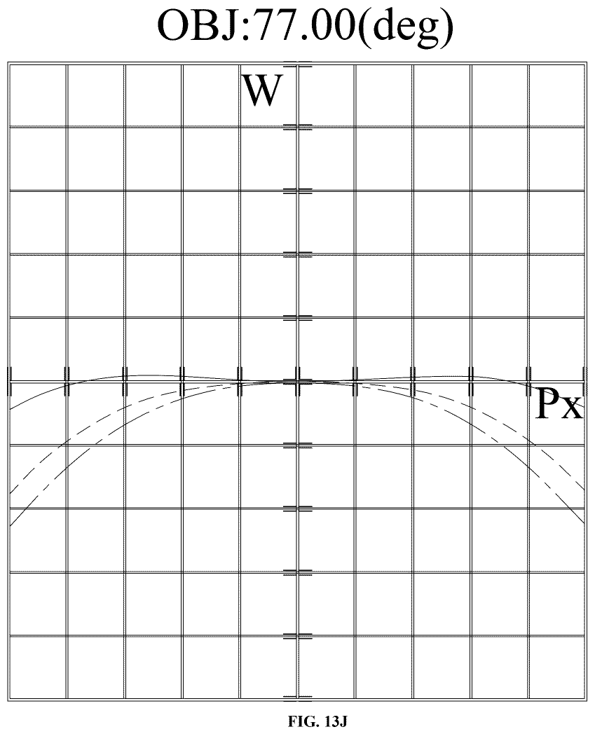

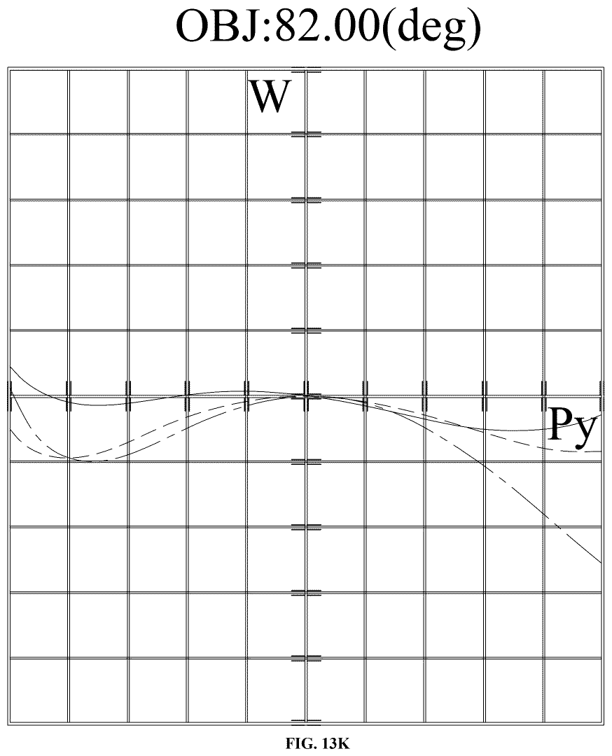

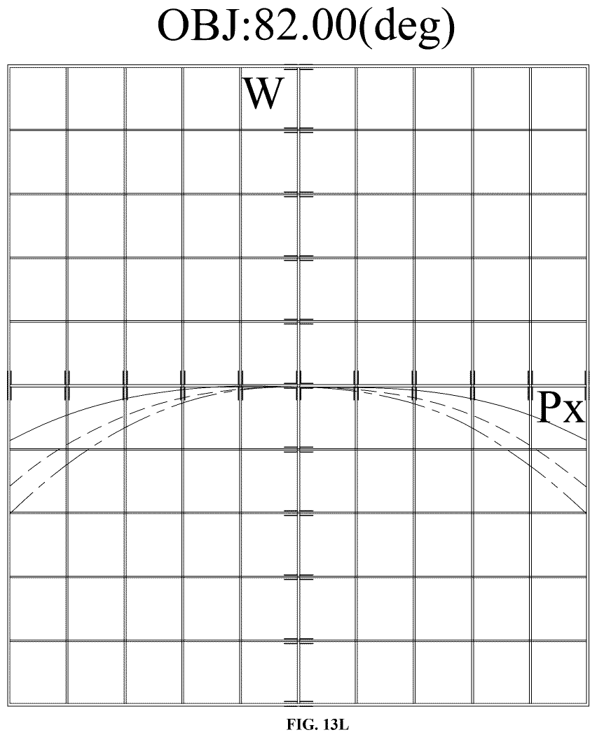

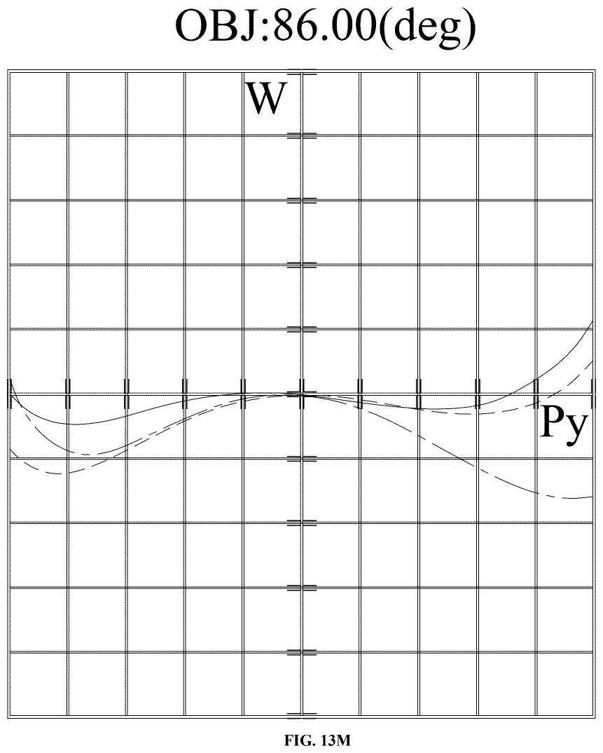

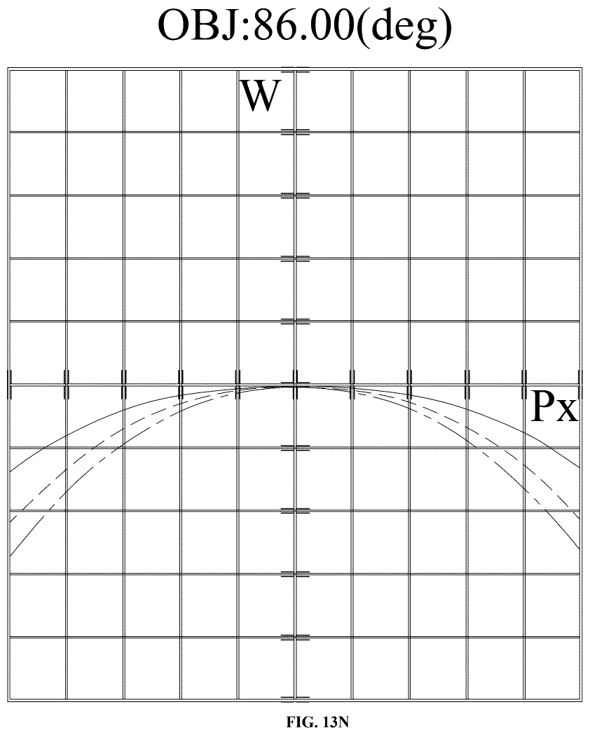

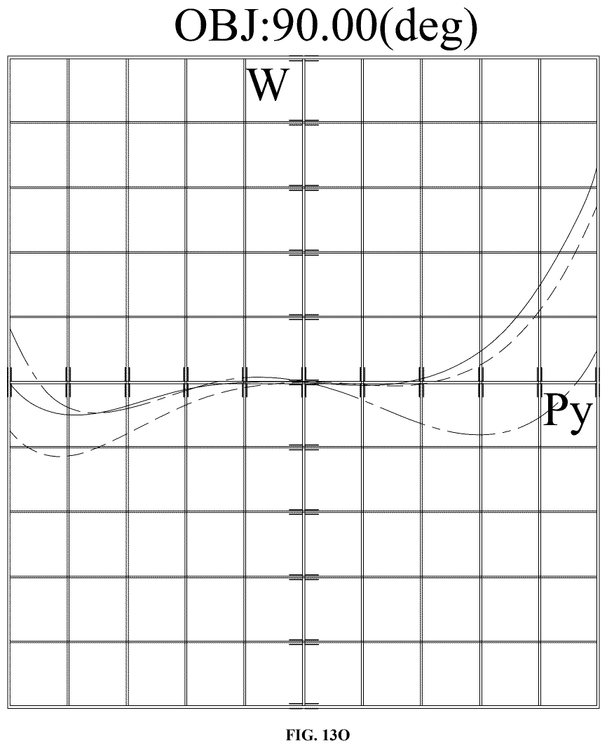

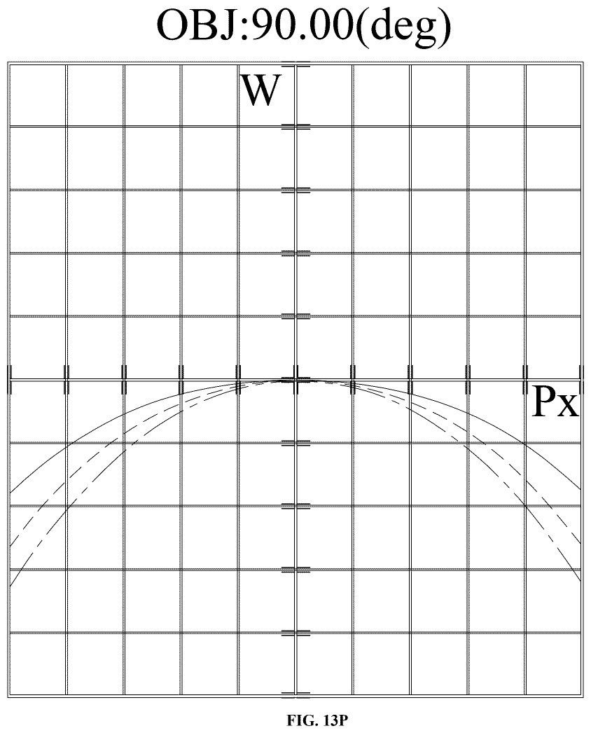

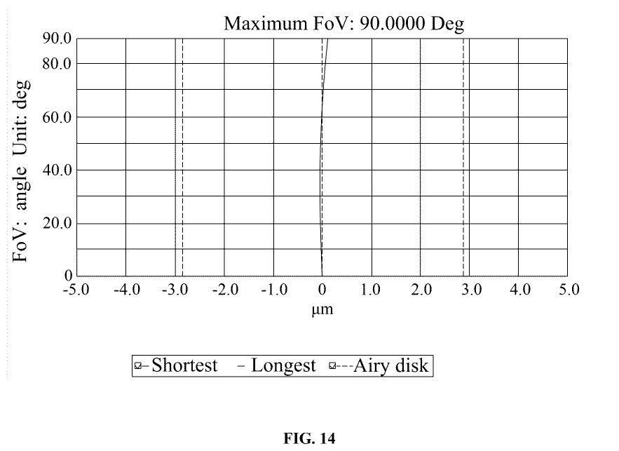

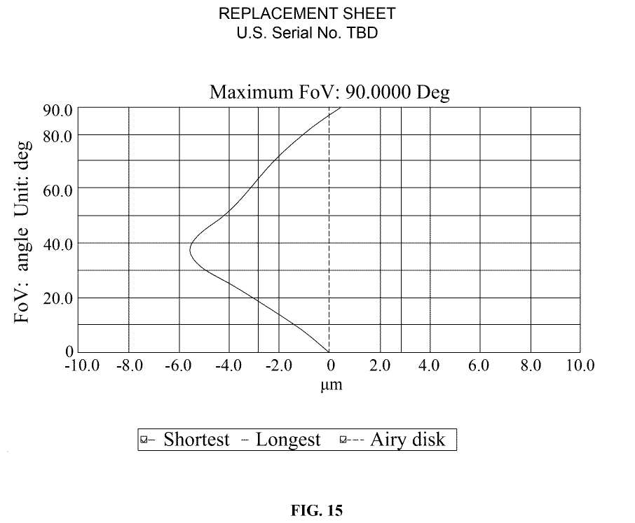

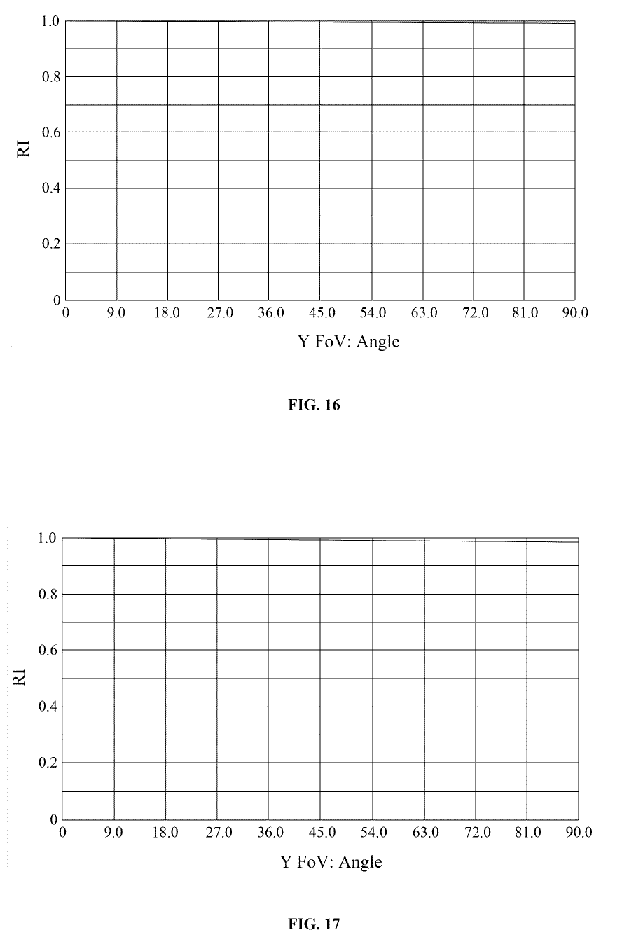

Performance test results of the large-FoV panoramic imaging systems shown in Table 2 and Table 3 are illustrated in FIG. 6 to FIG. 17. FIG. 6 and FIG. 7 respectively illustrate an MFT curve of the front FoV channel and an MFT curve of the rear FoV channel. The value of the MTF curve reflects the degree of restoration of the optical system for detailed information of the object in imaging. The greater value of the MTF indicates the better restorability for the detailed information of the object. FIG. 8 and FIG. 9 respectively illustrate a standard spot diagram of the front FoV channel and a standard spot diagram of the rear FOV channel, and reflect sizes of diffuse spots formed in imaging of the optical system for the spot object. The smaller spot diagram indicates the better imaging effect of the optical system. FIG. 10 and FIG. 11 respectively illustrate a distortion curve of the front FOV channel and a distortion curve of the rear FoV channel, and reflect distortion of the image and object. The smaller distortion indicates the higher similarity between the image and the object. FIG. 12 and FIG. 13 respectively illustrate wavefront aberrations of the front FoV channel under different FoVs and wavefront aberrations of the rear FOV channel under different FoVs, and reflect the aberrations of the optical system comprehensively. The smaller wavefront aberration indicates the smaller aberrations of the optical system, and the better imaging quality. FIG. 14 and FIG. 15 respectively illustrate a chromatic difference of magnification of the front FOV channel and a chromatic difference of magnification of the rear FoV channel, and reflect a difference between the vertical image heights in imaging of the optical system with light sources of different wavelengths. The smaller chromatic difference of magnification indicates the better consistency of image points in polychromatic light imaging of the optical system. FIG. 16 and FIG. 17 respectively illustrate an RI of the front FOV channel and an RI of the rear FOV channel, and reflect an energy distribution of the optical system on the image plane. The better consistency between the RIs indicates the more uniform luminance on the image plane of the optical system, and is more favorable for imaging.

With reference to the performance test results in FIG. 6 to FIG. 17, the large-FoV imaging system based on a multiplexed reflective surface provided by the embodiment has the high imaging quality through the front FoV channel and the rear FoV channel.

The technical characteristics of the above embodiments can be employed in arbitrary combinations. To provide a concise description of these embodiments, all possible combinations of all the technical characteristics of the above embodiments may not be described. However, these combinations of the technical characteristics should be construed as falling within the scope defined by the specification as long as no contradiction occurs.

Several examples are used herein for illustration of the principles and implementations of present disclosure. The description of the foregoing examples is used to help illustrate the method of present disclosure and the core principles thereof. In addition, those of ordinary skill in the art can make various modifications in terms of specific implementations and scope of application in accordance with the teachings of present disclosure. In conclusion, the content of the present specification shall not be construed as a limitation to present disclosure.

What is claimed is:

1. A large-field-of-view (FoV) panoramic imaging system based on a multiplexed reflective surface, comprising a panoramic annular head unit (PAHU) (10), a rear relay lens group (20), and an image sensor (30) that are collinear, wherein the PAHU (10) comprises a first lens (PAL1) and a second lens (PAL2) arranged sequentially from an object side to an image side; the first lens (PAL1) is a meniscus lens with a positive power, and comprises a front transmission surface (A1), a front reflective surface (A6), and a first transmission surface (A2); the second lens (PAL2) is a biconvex lens with a positive power, and comprises a multiplexed reflective surface (A3) and a second transmission surface (A8); and the rear relay lens group (20) comprises at least two lenses arranged sequentially from the object side to the image side;
the multiplexed reflective surface (A3) of the second lens (PAL2) is configured to reflect light from a glass side and light from an air side at the same time to respectively form a front FoV channel (40) and a rear FoV channel (50);
an object side of a first lens (RL1) in the rear relay lens group (20) is provided with a central circular area (S1) and an outer annular area (S2); and the central circular area (S1) and the outer annular area (S2) are two even aspheres with different surface parameters, and are respectively configured to deflect light from the front FoV channel (40) and light from the rear FoV channel (50); and
the large-FoV panoramic imaging system is capable of realizing an imaging FoV range of (35°-120°)*360°.

2. The large-FoV panoramic imaging system based on a multiplexed reflective surface according to claim 1, wherein the surface parameters of the central circular area (S1) and the outer annular area (S2) of the first lens (RL1) in the rear relay lens group (20) are designed as follows:
designing a surface parameter z(r) of a rotationally symmetric even asphere as:
$$z ( r ) = \{ \begin{matrix}\frac{{c}_{1} \cdot {r}^{2}}{1 + \sqrt{1 - ( 1 + {k}_{1} ) {c}_{1}^{2} \cdot {r}^{2}}} + {a}_{4} {r}^{4} + {a}_{6} {r}^{6} + … {a}_{16} {r}^{16} , 0 < r < {r}_{1} \\ \frac{{c}_{2} \cdot {r}^{2}}{1 + \sqrt{1 - ( 1 + {k}_{2} ) {c}_{2}^{2} \cdot {r}^{2}}} + {b}_{4} {r}^{4} + {b}_{6} {r}^{6} + … {b}_{16} {r}^{16} , {r}_{1} < r < {r}_{2} .\end{matrix}$$
wherein, z is a sag of the surface, and represents a difference between a coordinate of any point on the surface and a coordinate of a vertex of the surface along an optical axis, r₁ is a radial coordinate at a boundary between an inner asphere and an outer asphere, r₂ is a maximum radial coordinate of the outer annular area (S2), c₁ and c₂ are respectively a curvature of the inner asphere at a vertex and a curvature of the outer asphere at a vertex, k₁ and k₂ are respectively a conic constant of the inner asphere and a conic constant of the outer asphere, and aᵢ and bⱼ (i, j=4, 6, 8, . . . , 16) are respectively a high-order aspheric coefficient of the inner asphere, and a high-order aspheric coefficient of the outer asphere; and
and when r=r₁, a sag of the object side of the first lens (RL1) changes abruptly, with a variation expressed as:
$$Δ z ( {r}_{1} ) = \{ \frac{{c}_{2} \cdot {r}_{1}^{2}}{1 + \sqrt{1 - ( 1 + {k}_{2} ) {c}_{2}^{2} \cdot {r}_{1}^{2}}} + {b}_{4} {r}_{1}^{4} + {b}_{6} {r}_{1}^{6} + … {b}_{16} {r}_{1}^{16} \} - \{ \frac{{c}_{2} \cdot {r}_{1}^{2}}{1 + \sqrt{1 - ( 1 + {k}_{1} ) {c}_{1}^{2} \cdot {r}_{1}^{2}}} + {a}_{4} {r}_{1}^{4} + {a}_{6} {r}_{1}^{6} + … {a}_{16} {r}_{1}^{16} \} ;$$
the light from the front FoV channel (40) is refracted by the central circular area (S1) of the first lens (RL1) in the rear relay lens group (20), with a series of intersections with the central circular area (S1), an intersection with a maximum radial coordinate being labeled as Q₁; the light from the rear FoV channel (50) is reflected by the outer annular area (S2) of the first lens (RL1), with a series of intersections with the outer annular area (S2), an intersection with a minimum radial coordinate being labeled as Q₂; and in order to constrain a falling position of the light, the radial coordinate r_{Q}_{₁} of the Q₁ and the radial coordinate r_{Q}_{₂} of the Q₂ satisfy:
$${r}_{{Q}_{1}} < {r}_{{Q}_{2}} ;$$
the light from the front FoV channel (40) is refracted by the front transmission surface (A1) and the first transmission surface (A2), reflected by the multiplexed reflective surface (A3) and the front reflective surface (A6), and transmitted by the second transmission surface (A8), thereby entering the rear relay lens group (20); the light from the rear FOV channel (50) is reflected by the multiplexed reflective surface (A3) to enter the rear relay lens group (20); the light from the front FoV channel (40) has a series of intersections with the multiplexed reflective surface (A3), an intersection with a minimum radial coordinate being labeled as P₁; the light from the rear FoV channel (50) also has a series of intersections with the multiplexed reflective surface (A3), an intersection with a minimum radial coordinate being labeled as P₂; the light from the front FoV channel (40) has a series of intersections with the second transmission surface (A8) of the second lens (PAL2), an intersection with a maximum radial coordinate being labeled as P₃; and in order not to obstruct the light from the two channels, the radial coordinate r_{P}_{₁} of the P₁, the radial coordinate r_{P}_{₂} of the P₂, and the radial coordinate r_{P}_{₃} of the P₃ satisfy the following constraints:
$${r}_{{P}_{1}} > {r}_{{P}_{3}} ; and {r}_{{P}_{2}} > {r}_{{P}_{3}} ;$$
the light from the front FoV channel (40) at angles of 35° and 90° is respectively intersected with an r-axis on an image plane of the image sensor (30) at P₄ and P₅; the light from the rear FoV channel (50) at angles of 90° and 120° is respectively intersected with the r-axis on the image plane at P₇ and P₆; images of the two channels are not overlapped; and a radial coordinate r_{P}_{₅} of the P₅ and a radial coordinate r_{P}_{₆} of the P₆ satisfy the following constraint:
r_{P}_{₅}<r_{P}_{₆}; and
in design optimization, in order to make Δz(r₁) approach zero, constraints r_{Q}_{₁}<r_{Q}_{₂}, r_{P}_{₁}>r_{P}_{₃}, r_{P}_{₂}>r_{P}_{₃}, and r_{P}_{₅}<r_{P}_{₆} are added to a merit function to perform parameter optimization on z(r), thereby determining the surface parameters of the central circular area (S1) and the outer annular area (S2).

3. The large-FoV panoramic imaging system based on a multiplexed reflective surface according to claim 1, wherein an object-side curvature radius R_{A}_{₁} and an image-side curvature radius R_{A}_{₂} of the first lens (PAL1) satisfy the following relationship:
$$0.7 < \frac{{R}_{{A}_{1}}}{{R}_{{A}_{2}}} < 0.75 .$$

4. The large-FoV panoramic imaging system based on a multiplexed reflective surface according to claim 1, wherein an object-side curvature radius R_{A2} and an image-side curvature radius R_{A}_{₃} of the second lens (PAL2) satisfy the following relationship:
$$2.13 < \frac{{R}_{{A}_{2}}}{{R}_{{A}_{3}}} < 2.18 .$$

5. The large-FOV panoramic imaging system based on a multiplexed reflective surface according to claim 1, wherein a total track length TTL_{head} of the PAHU (10) and a total track length TTL_{rear relay lens group} of the rear relay lens group (20) satisfy the following relationship:
$$0.65 < \frac{{TTL}_{PAHU}}{{TTL}_{rear relay lens group}} < 0.7 .$$

6. The large-FoV panoramic imaging system based on a multiplexed reflective surface according to claim 1, wherein the rear relay lens group (20) comprises seven lenses arranged sequentially from the object side to the image side, comprising a first lens (RL1), a second lens (RL2), a third lens (RL3), a fourth lens (RL4), a fifth lens (RL5), a sixth lens (RL6), and a seventh lens (RL7); the first lens (RL1), the third lens (RL3), the fourth lens (RL4), the fifth lens (RL5), and the seventh lens (RL7) are meniscus lenses; the second lens (RL2) is a biconcave lens; and the sixth lens (RL6) is a biconvex lens.

7. The large-FoV panoramic imaging system based on a multiplexed reflective surface according to claim 1, wherein the first lens (PAL1) and the second lens (PAL2) are cemented together, such that the second lens (PAL2) is provided with the first transmission surface (A2).

8. The large-FoV panoramic imaging system based on a multiplexed reflective surface according to claim 6, wherein the second lens (RL2) and the third lens (RL3) are cemented together; and the sixth lens (RL6) and the seventh lens (RL7) are cemented together.
